(19) United States
(12) Patent Application Publication
(10) Pub. No.: US 2004/0223566 A1
(43) Pub. Date: Nov. 11, 2004

(54) Method and apparatus for skew adjustment, data transmission system having skew adjustability

(75) Inventor: Hideki Yamashita, Hyogo (JP)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: AGILENT TECHNOLOGIES, INC.

(21) Appl. No.: 10/768,351

(22) Filed: Jan. 30, 2004

(30) Foreign Application Priority Data
Jan. 30, 2003 (JP) 2003-022657

(51) Int. Cl. H04L 7/00

(52) U.S. Cl. 375/354

(57) ABSTRACT

A data transmission system with which optimal skew adjustment is achieved by a structure transmitting skew adjustment signals in place of data signals and detecting the amount of skew between the clock signals and the data signals. The skew adjustment signals are alternating signals with twice the period of the clock signals, and one signal state persists for a longer time than the other signal state.

### BACKGROUND OF THE INVENTION 1. Field of the Invention

The present invention pertains to a data transmission system and in particular, relates to a data transmission system including skew adjustment at any transmission rate.

2. Description of the Prior Art

Changes in transmission signal waveform greatly influence the transmission quality of data transmission systems. Reducing fluctuations in data transition timing, that is, jitter reduction, is a particularly important topic associated with data transmission systems.

Methods of reducing the effects of jitter by retiming data using a clock synchronized with the data in the middle or at the end of the transmission path, and similar methods have been used with high-speed data transmission systems in the past. Specifically, the data and the clock signals are transmitted concurrently in a data transmission system and the state of the data is kept in response to the transition of the clock using a flip-flop or similar means, in the middle of the transmission path or at the receiver.

However, in the instance of the above-described types of data transmission systems, there are cases in which, if the time correlation between the clock and the data is inappropriate, the data transmitted to the receiver will be unstable. This unstable state is also referred to as metastable. When the signals that are input by the data transmission system cannot comply with the set-up time or the hold time using a flip-flop or latch, the output signals will not be either of the binary digits “0” or “1” and will be in an unstable state. In general, this state does not last long and does not always occur. For example, when the timing of the clock and data signals slips due to a delay in data creation by the transmitter or a difference in the amount of delay on the transmission path, or similar events, and the transmission timing of the two signals moves closer together, there are cases where data transmitted to the receiver will be metastable. This type of difference in the timing of the clock and the data signals is called skew. It can also be said that, ideally, this skew is the magnitude of the time difference between delays of different signals in the transmission system.

Therefore, in conventional data transmission systems, the receiver comprises a delay circuit for adjusting the amount of delay in the transmission path in order to eliminate the negative impact of skew. In addition, the data transmission system will further comprise complex circuits and additional signal lines for performing an optimal skew adjustment optimal for a transmission rate (see Japanese Kokai Patent No. Hei 5(1993)-110,550 (FIG. 1) or Japanese Kokai Patent No. Hei 10(1998)-164,037 (FIG. 1)).

Complex circuits and additional signal lines become factors that interfere with miniaturization, cost reduction, and the like, of data transmission systems.

In light of the fore-going facts, there exists a need for a data transmission system having a simple skew adjustment structure.

### SUMMARY OF THE INVENTION

A first aspect of the present invention is characterized by a method where the skew between clock signals and data signals is adjusted by changing the time delay applied to the clock signals or the data signals in a data transmission system, wherein the clock signals and the data signals are individually transmitted and received. The method comprises transmitting skew adjustment signals, which are alternating binary digit signals having twice the period of the above-mentioned clock signals and one signal state of which persists for a longer time than the other signal state, in place of data signals, sampling the above-mentioned skew adjustment signals in response to the above-mentioned clock signals, creating delay control signals that change with the statistical properties of the above-mentioned skew adjustment signals that have been sampled, and adjusting the time delay in response to the delay control signals.

Moreover, a second aspect of the present invention is characterized by means of the first aspect of the present invention, wherein the above-mentioned delay control signals being created by integrating the above-mentioned skew adjustment signals that have been sampled.

Furthermore, a third aspect of the present invention is characterized by means of the first or second aspects of the present invention, wherein the above-mentioned skew adjustment signals are asymmetric rectangular waves having twice the period of the above-mentioned clock signals.

In addition, a fourth aspect of the present invention is characterized by means of any of the first through third aspects of the present invention, wherein the time delay is applied to the mentioned data signals and the above-mentioned skew adjustment signals.

A fifth aspect of the present invention is characterized by means of the first through fourth aspects of the present invention, wherein the time delay is the amount of delay obtained by subtracting the original time delay from the ideal time delay, the ideal time delay is the time delay with which the probability that transition of clock signals and transition of data signals will occur simultaneously is at its lowest, and the original time delay is the amount of skew that is still present between clock signals and data signals, even when the time delay is adjusted to its lowest, and is calculated from each of the time delays adjusted for at least two transmission rates.

Furthermore, a sixth aspect of the present invention is characterized in that an apparatus with which skew between clock signals and data signals is adjusted in a data transmission system in which clock signals and data signals are individually transmitted and received comprises means for transmitting skew adjustment signals, which are alternating binary digit signals having twice the period of the above-mentioned clock signals and one signal state of which persists for a longer time than the other signal state, in place of data signals, means for sampling the skew adjustment signals in response to the clock signals, means for creating delay control signals that change with the statistical properties of the skew adjustment signals that have been sampled, and means for applying time delay to the clock signals or the skew adjustment signals in response to the delay control signals.

Moreover, a seventh aspect of the present invention is characterized by means of the sixth aspect of the present invention, wherein the means for creating delay control signals creates the delay control signals by integrating the skew adjustment signals that have been sampled.

In addition, the eighth aspect of the present invention is characterized in that by means of the sixth or seventh aspect of the present invention, the above-mentioned skew adjustment signals are asymmetric rectangular waves having twice the period of the above-mentioned clock signals.

A ninth aspect of the present invention is characterized by means of any of the sixth through the eighth aspects of the invention, wherein the time delay means applies delay to the data signals and the skew adjustment signals.

A The tenth aspect of the present invention is characterized, by means of any of the sixth through the ninth aspects of the present invention, wherein the time delay is the amount of delay obtained by subtracting the original time delay from the ideal time delay, the ideal time delay is the time delay with which the probability that transition of clock signals and transition of data signals will occur simultaneously is at its lowest, and the original time delay is the amount of skew that is still present between clock signals and data signals, even when the time delay is adjusted to its lowest, and is calculated from each of the time delays adjusted for at least two transmission rates.

The eleventh aspect of the present invention is characterized by a data transmission system in which clock signals and data signals are individually transmitted and received and which comprises a transmitter, a receiver, and a delay device for adjusting skew between the clock signals and the data signals, the mentioned transmitter transmits the mentioned clock signals and skew adjustment signals which are alternating binary digit signals having twice the period of the clock signals and one signal state of which persists for a longer time than the other signal state, the receiver samples the skew adjustment signals in response to the clock signals and creates delay signals that change with the statistical properties of the skew adjustment signals that have been sampled, and the delay device adjusts the amount of delay in response to the delay control signals.

A twelfth aspect of the present invention is characterized by means of the eleventh aspect of the present invention, wherein the receiver creates delay control signals by integrating the skew adjustment signals that have been sampled.

A thirteenth aspect of the present invention is characterized by means of the eleventh or twelfth aspect of the present invention, wherein the mentioned skew adjustment signals are asymmetric rectangular waves having twice the period of the clock signals.

A fourteenth aspect of the present invention is characterized by means of any of the eleventh through thirteenth aspects of the present invention, wherein the delay device delays the data signals and the skew adjustment signals.

A fifteenth aspect of the present invention is characterized by means of any of the eleventh through the fourteenth aspects of the present invention, wherein the time delay is the amount of delay obtained by subtracting the original time delay from the ideal time delay, the ideal time delay is the time delay with which the probability that transition of clock signals and transition of data signals will occur simultaneously is at its lowest, and the original time delay is the amount of skew that is still present between clock signals and data signals, even when the time delay is adjusted to its lowest, and is calculated from each of the time delays adjusted for at least two transmission rates.

A sixteenth aspect of the present invention is characterized by means of any of the eleventh through the fifteenth aspects of the present invention, wherein the transmitter and the are connected together by clock signal lines and data signal lines, and the transmitter supplies the clock signals to the clock signal lines and the skew adjustment signals to the data signal lines.

A seventeenth aspect of the present invention is characterized by means of any of the eleventh through the sixteenth aspects of the present invention, wherein the transmitter comprises the delay device and a binary signal generating means that generates the above-mentioned data signals and the skew adjustment signals, and binary signal generating means generates data signals and skew adjustment signals in response to both rising edges and trailing edges of clock signals.

### BRIEF DESCRIPTION OF THE DRAWINGS

FIG. 1 is a drawing illustrating the structure of serial data transmission system 100;

FIG. 2 is a drawing illustrating the structure of data generator 220 inside the system of the present invention;

FIG. 3 is a timing chart of signals Vin, Vmp, and Vout in waveform adjustment device 222 in the system of the present invention;

FIG. 4 is a timing chart of clock signals and skew adjustment signals received by flip-flop 310 in the system of the present invention;

FIG. 5 is a drawing illustrating the output signals of integrator 320 in the system of the present invention;

FIG. 6 is a drawing illustrating the output signals of integrator 320 at two transmission rates;

FIG. 7 is a drawing illustrating the structure of serial data transmission system 400 of the present invention;

FIG. 8 is a drawing illustrating the structure of data generator 520 inside the system of the present invention; and

FIG. 9 is a drawing showing the structure of parallel data transmission system 700 of the present invention.

### DETAILED DESCRIPTIOPN OF THE INVENTION

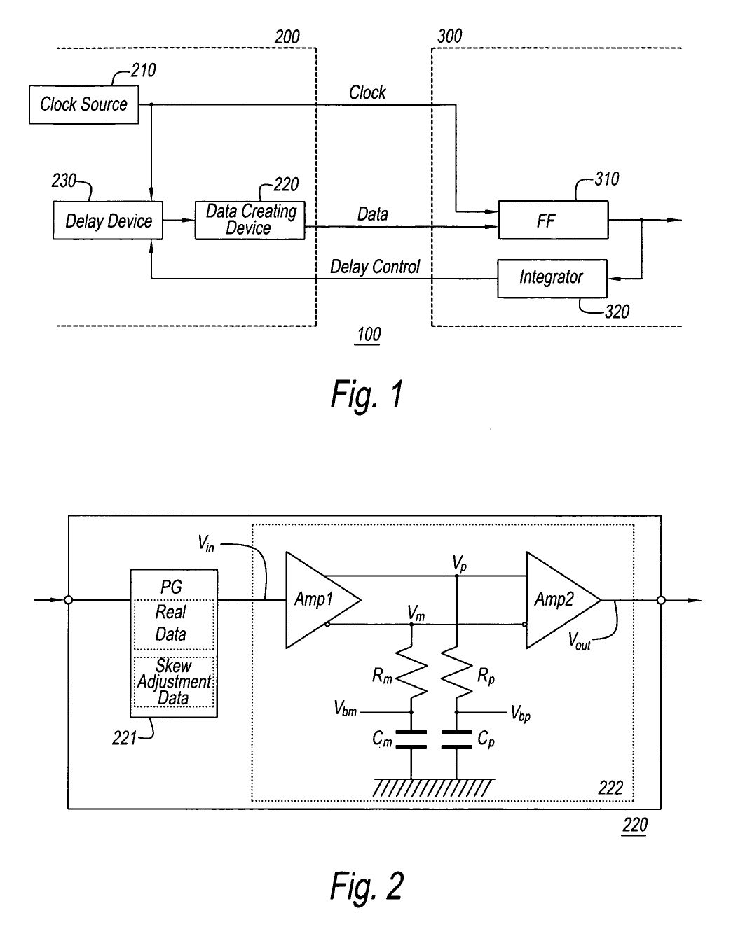

The present invention will now be described based on preferred embodiments shown in the attached drawings. The first embodiment is a serial data transmission system with which skew adjustment is performed by the method of the present invention. A structural diagram of this system is shown in FIG. 1.

A serial data transmission system 100 in FIG. 1 comprises a transmitter 200 and a receiver 300.

Transmitter 200 comprises a clock generator 210, a data generator 220, and a delay device 230. Clock generator 210 is a device that supplies the clock signals to transmitter 200 and the clock signals are transmitted to outside the device. By means of the present embodiment, the clock signals that are supplied by clock generator 210 are rectangular wave signals. Delay device 230 is a device that applies a specific time delay to the inputted signals. It receives the clock signals from clock generator 210, applies time delay to the clock signals, and outputs the delayed signals. The amount of delay that is applied to the clock signals by delay device 230 is increased or decreased in response to outside signals. Data generator 220 is the device that creates the data signals that are transmitted by transmitter 200. Data generator 220 creates either real data signals or skew adjustment signals in response to the clock signals to which the time delay has been applied by delay device 230, and outputs the resulting signals. The skew adjustment signals are signals that alternate between the binary digits “0” and “1,” and have twice the period of the clock signals. Moreover, one of the signal states of the binary digits of the skew adjustment signals persists for a longer time than the other signal state. This means, the duty ratio of the skew adjustment signals is set at either greater than 50% or less than 50%. By means of the present embodiment, the duty ratio of the skew adjustment signals is greater than 50%.

Data generator 220 will now be described in detail. The internal clock of data generator 220 is shown in FIG. 2. Data generator 220 comprises a pattern generator 221 (PG 221 in the figure) and a waveform adjustment device 222. Pattern generator 221 generates real data signals or skew adjustment data signals in response to a rise in the clock signal to which time delay is applied by delay device 230. It should be noted that the skew adjustment data signals are data digits that alternate between “0” and “1.” Both of these data digits can be housed from the beginning in pattern generator 221, or either one can be housed in pattern generator 221 as needed. Waveform adjustment device 222 adjusts the waveform of the output signals of pattern generator 221 so that the period of time of either “0” or “1” is longer or shorter than the other period. Waveform adjustment device 222 comprises an amplifier Amp1 and an amplifier Amp2. Amplifier Amp1 is the amplifier that converts a single end signal Vin that is input to waveform adjustment device 222 to differential signals and outputs the resulting signals. Amplifier Amp2 is the amplifier that converts the differential signals that are output by amplifier Amp1 to a single end differential signal and outputs the resulting signal. A positive signal Vp and a minus signal Vm that are output by Amp1 are applied through a resistor Rp and a resistor Rm as bias voltages Vbp and Vbm, respectively, at waveform adjustment device 222. Capacitors Cm and Cp are used for stabilizing the voltage level of bias voltages Vbp and Vbm.

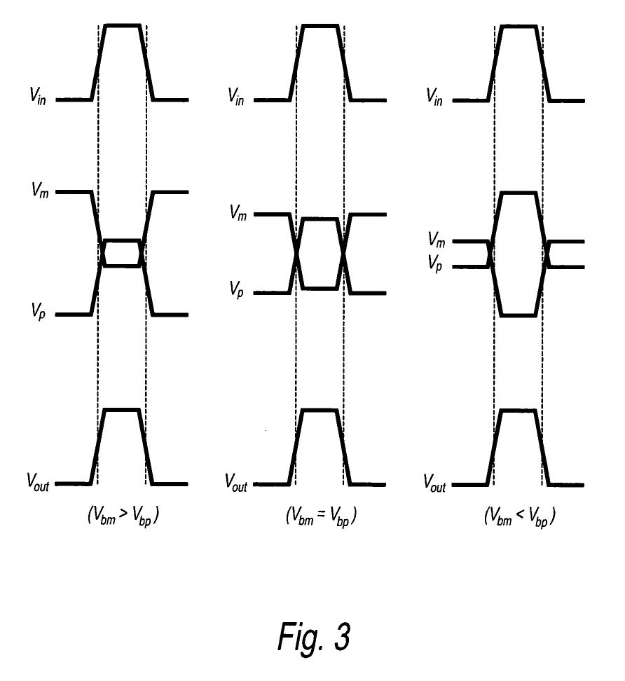

The waveform adjustment operation of waveform adjustment device 222 will now be described. The timing chart of signals Vin, Vm, Vp, and Vout in waveform adjustment device 222 is shown in FIG. 3 for clarification. It should be noted that signal Vout is the output signal of amplifier Amp2. The left side of FIG. 3 represents the case when bias voltage Vbm is larger than bias voltage Vbp. In this case, the period of time of “1” of signal Vout is short in comparison to that of signal Vin. Moreover, the center of the figure represents the case where bias voltage Vbm and bias voltage Vbp are the same. In this case, the period of time of “1” is the same for signal Vout and signal Vin. Furthermore, the right of the figure is the case where bias voltage Vbp is larger than bias voltage Vbm. In this case, the period of time of “1” of signal Vout is long in comparison to that of signal Vin. By means of the present embodiment, bias voltage Vbp is set larger than bias voltage Vbm. Waveform adjustment device 222 adjusts the duty ratio of the input signals by the above-mentioned operation and outputs the resulting signal.

Now, receiver 300 comprises a flip-flop 310 (FF 310 in the figure) and an integrator 320. Flip-flop 310 latches data signals that have been output by data generator 220 in response to the clock signals supplied from clock generator 210 and outputs the resulting signals. By means of the present embodiment, flip-flop 310 is a D-flip-flop and performs a latch operation in response to a rise in the clock signal. Integrator 320 is the device that receives output signals of flip-flop 310 and detects the amount of skew between the clock signals and the data signals. Integrator 320 outputs signals that change in accordance with the amount of skew between the clock signals and the data signals. The output signals of integrator 320 are fed back to delay device 230 as delay control signals.

Next, the skew adjustment operation of the above-mentioned serial data transmission system 100 will be described. Skew adjustment is performed by the method of the present invention. The skew adjustment method of the present invention involves creating signals whose level changes with the amount of time delay applied to skew adjustment signals and adjusting the amount of time delay applied to the skew adjustment signals, while referring to the signals that have been created. Specifically, first, data generator 220 is set so that it outputs skew adjustment signals. Data generator 220 outputs skew adjustment signals in response to the clock signals to which time delay has been applied by delay device 230 with this setting. Skew adjustment signals are transmitted from transmitter 200 to receiver 300 through data lines. Next, skew adjustment signals are latched by flip-flop 310 in response to the clock signals supplied from transmitter 200. The incidence of “0” and “1” in signals latched by flip-flop 310 changes with the amount of time delay applied to the skew adjustment signals. Consequently, the level of the signals output by integrator 320 changes with the amount of time delay applied to the skew adjustment signals. The optimum time delay can be applied to the clock signals supplied to data generator 220 by employing the output signals of integrator 320.

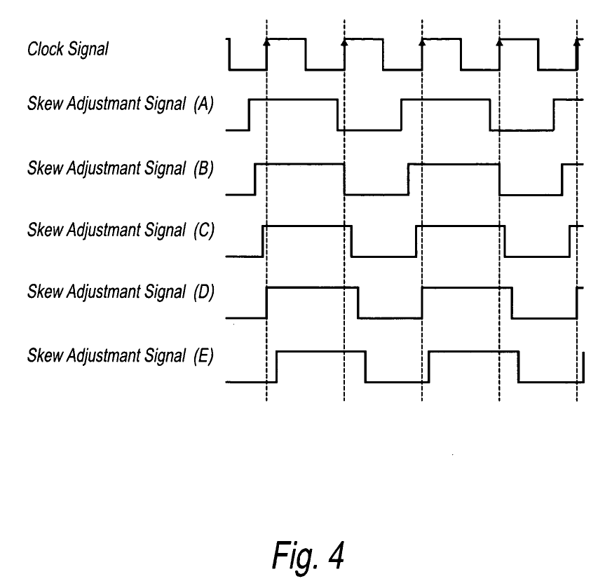

Changes in the amount of the time delay applied to the skew adjustment signals and the incidence of “0” and “1” in the output signals of flip-flop 310 will now be described. The timing chart of the clock and skew adjustment signals received by flip-flop 310 is shown in FIG. 4 for clarification. Different time delays are applied to skew adjustment signals A, B, C, D, and E in FIG. 4. The time delay applied to skew adjustment signal A is the smallest, and the time delay that is added increases in succession, with the time delay applied to skew adjustment signal E being the largest. “0” and “1” appear alternately in the output signals of flip-flop 310 with every rise in the clock signal when flip-flop 310 receives skew adjustment signals A. A rise in the clock signal and a fall in the skew adjustment signal are simultaneously generated when flip-flop 310 receives skew adjustment signal B. In this case, there is a strong possibility that the output signals of flip-flop 310 will be metastable. Consequently, “1”, and unstable digits that are not “0” or “1” alternately appear in the output signals of flip-flop 310. The unstable digits are in between “0” and “1”. Unstable digits that are not “0” or “1” are hereafter called metastable digits. Flip-flop 310 always outputs “1” when flip-flop 310 receives skew adjustment signal C. By means of the present embodiment, the duty ratio of the skew adjustment signals is greater than 50% and therefore, “1” is always continuously output. If the duty ratio of the skew adjustment signals is less than 50%, flip-flop 310 will always output “0”. A rise in the clock signal and a rise in the skew adjustment signal will be simultaneously generated when flip-flop 310 receives skew adjustment signal D. In this case, there is a strong possibility that the output signals of flip-flop 310 will still be metastable. Consequently, “1”, and metastable digits will alternately appear in the output signals of flip-flop 310. “0” and “1” will alternately appear in the output signals of flip-flop 310 with each rise in the clock signal when flip-flop 310 receives skew adjustment signal E.

It should be noted that the jitter effect that is contained in the signals is not shown in FIG. 4 for convenience. Nevertheless, jitter is contained in the clock signals and skew adjustment signals that are actually transmitted. The likelihood that the output signals of flip-flop 310 will be metastable increases as the rise in the clock signal and the transition timing of the skew adjustment signal come closer to one another. It should be noted that whether the output signal of flip-flop 310 is “0”, “1”, or a metastable digit is dependent on the statistical properties of the jitter.

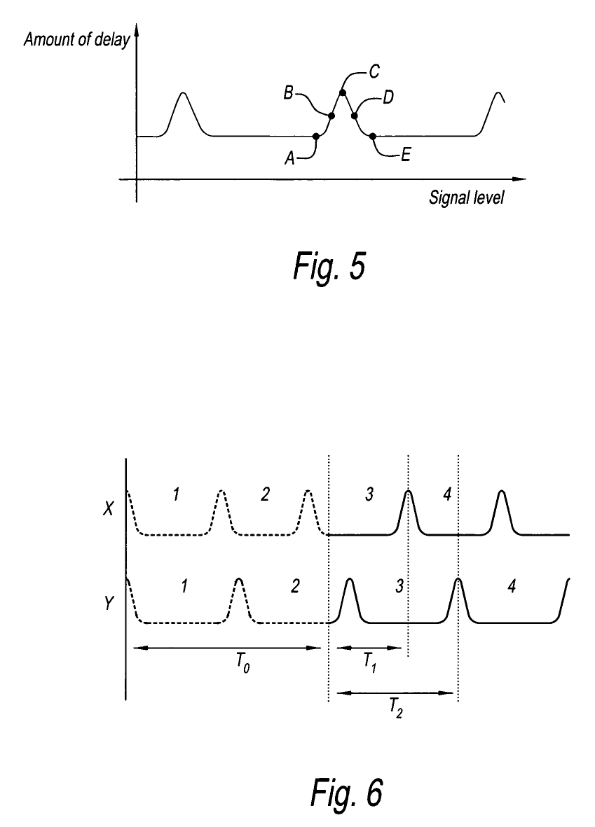

Next, the correlation between the amount of time delay applied to the skew adjustment signals and the output signals of integrator 320 will be described. The output signals of integrator 320 are shown in FIG. 5 for clarification. The level of the output signals of integrator 320 changes periodically in the shape of the peaks in FIG. 5, with level “0.5” in between the level representing “0” and the level representing “1” as the base. The level at the apex of this peak is the level representing “1”. The five points on the output signals in FIG. 5 show when skew adjustment signals A through E are received at flip-flop 310. When flip-flop 310 receives skew adjustment signals A or E, “0” and “1” appear equally in the output signals of flip-flop 310 and therefore, the output signal level of integrator 320 becomes “0.5”. When flip-flop 310 receives skew adjustment signal B or D, “1”, and metastable digits will alternately appear in the output signals of flip-flop 310, and therefore the output signal level of integrator 320 exist between “0.5” and “1”.

As previously mentioned, FIG. 4 does not show the effect of jitter contained in the signals. Nevertheless, the timing of the clock signals and the skew adjustment signals that are actually transmitted changes with the effects of jitter. These changes in timing have an effect on the level of the output signals of integrator 320. For instance, when flip-flop 310 receives skew adjustment signal B or D, the output signals of flip-flop 310 consistently change between “0” and “1” in accordance with the jitter properties. As previously mentioned, integrator 320 outputs signals, the level of which changes with the time correlation between the skew adjustment signals and the clock signals. It should be noted that when bias voltage Vbp is set lower than bias voltage Vbm in waveform adjustment device 222, the level of the output signals of integrator 320 changes periodically in the shape of dips with the intermediate level “0.5” as the base. In the end, peaks or dips appear periodically in the delay control signals as a result of adjustment of the bias voltage Vbp and the bias voltage Vbm. The position of the apex of the peak and the base of the dip can be easily specified and therefore, delay control signals are suitable to reference for delay control.

Finally, operation of delay device 230 will be described. The output signals of above-mentioned integrator 320 are fed back as delay control signals from receiver 300 to transmitter 200 by a system that is appropriate for reception of signals by delay device 230. Delay device 230 applies the optimal time delay to the clock signal that is supplied to data generator 220 while referring to the output signals of this integrator 320. By means of this embodiment, when flip-flop 310 receives skew adjustment signal C, the transition of the data signal and the transition of the clock signal always overlaps, and therefore, the time correlation between the data signal and the clock signal becomes the most inappropriate. In this case, there is a strong possibility that all of the data signals latched by flip-flop 310 are metastable. Consequently, if the time delay applied to delay device 230 in serial data transmission system 100 is set so that it corresponds to the center between the apexes of two peaks that appear in the output symbols of integrator 320, skew adjustment can be performed so that the effect of jitter will be minimized.

In order to transmit actual data after completing the skew adjustment, pattern generator 221 is set so that real data are generated and waveform adjustment device 222 is set so that bias voltage Vbm and bias voltage Vpb are the same.

As clarified by the above-mentioned description, the devices responsible for skew adjustment in the present embodiment are data generating device 220, delay device 230, flip-flop 310, and integrator 320.

Skew adjustment that is optimal for each transmission rate is conducted by the first embodiment. In the end, skew adjustment before transmitting real data is necessary each time the transmission rate changes. Consequently, when the transmission rate frequently changes, problems develop, such as a reduction in the transmission efficiency with frequent skew adjustment. Therefore, a second embodiment that solves this type of problem is described below.

The second embodiment is a serial data transmission system having the same structure as the first embodiment and is analogous to the system shown in FIG. 1. However, the skew adjustment method of the second embodiment is different from that of the first embodiment. By means of the skew adjustment method of the second embodiment, the amount of skew that occurs in the serial data transmission system is identified with skew adjustment at two or more different transmission rates, the optimal amount of time delay that should be applied by delay device 230 can be calculated in a short time at any transmission rate.

The skew adjustment method of the second embodiment is described in detail below. The output signals of integrator 320 are shown in FIG. 6 for clarification. Top signal line X represents the output signals of integrator 320 at transmission rate RX. Moreover, bottom signal line Y represents the output signals of integrator 320 at transmission rate RY. It should be noted that transmission rate RX is faster than transmission rate RY. Moreover, T0 is the amount of skew still present between the clock signal and the data signal when the amount of time delay applied by delay device 230 is minimized. T0 is not the delay added intentionally but delay which serial data transmission system 100 adds primitively. T0 is understood to be a representative approximate value and is not understood to be an exact value. The part of signal line X and signal line Y whose level changes with this T0 is shown by the broken line in FIG. 6, while the part where the level changes with the time delay applied by delay device 230 is shown by the solid line. The period of level changes of signal line X and signal line Y is inversely proportional to the transmission rate. Consequently, when the periods of level changes of signal line X and signal line Y are TX and TY, respectively, the following relationship is established:

RX•TX=RY•TY Formula 1

T0 is attributed to the data generator 220, differences in transmission paths, and similar factors and as previously mentioned, is understood to be an approximate value. Therefore, it is possible to know exactly the periods of level changes in signal line X and signal line Y. Thus, formula 1 becomes formula 2 when represented using T0.

RX·(T0−T1)=RY·(T0+T2) Formula 2

Here, T1 and T2 are the amount of time delay applied by delay device 230 so that the periods of level changes in signal line X and signal line Y are the same. Formula 2 can be further rewritten as formula 3.

$$T0 = \frac{R Y \cdot T2 - R X \cdot T1}{R X - R Y} \qquad Formula 3$$

If RX, RY, T1, and T2 are known, T0 can be calculated accurately from the above-mentioned formula. Therefore, a skew adjustment that is optimal for any transmission rate can be performed in a short time. For instance, when the transmission rate is R and the time delay applied by delay device 230 is T in serial data transmission system 100 of the present embodiment, the transition of the data and the clock signals will always overlap in cases in which R×(T0+T) is a natural number and therefore, the time correlation between the data and the clock signals is the most inappropriate. Consequently, skew adjustment in serial data transmission system 100 can be performed so that the effect of jitter is minimized by setting R×(T0+T)=N+0.5 (N is a natural number) when R is the transmission rate. In short, when skew adjustment is performed at two transmission rates to pre-determine T0 it is possible thereafter to find by calculation the optimal amount of time delay that should be applied by delay device 230 at any transmission rate and therefore, it is not necessary to search for the amount of delay that corresponds to the center between the apexes of two peaks that appear in the output signals of integrator 320 as illustrated by the first embodiment, and the optimal amount of delay with which the probability that the transition of data signals and the transition of the clock signals will occur simultaneously is at its lowest can be set in a short amount of time.

By the way, the devices and transmission paths through which signals pass each have unique group delay properties. In general, these group delay properties are properties such that the amount of delay varies with frequency. Consequently, when the frequency distribution of the signals that are input changes from moment to moment, the amount of jitter applied to the signals that pass through the devices and transmission paths is generally high. Real data signals are examples of signals whose frequency distribution changes from moment to moment. On the other hand, the amount of jitter applied to the signals that pass through the devices and transmission paths is generally small when the distribution frequency of the signals that are input is constant. Clock signals and similar signals are examples of signals whose frequency distribution is constant. This applies also to pattern generator 221, waveform adjustment device 222, delay device 230, and similar devices. Consequently, it is preferred that by means of serial data transmission system 100, there be as few devices as possible through which real data signals pass and the length of the paths through which real data signals pass be as short as possible in order to control as much as possible the amount of jitter that the entire system generates. A third embodiment that is structured so that the amount of jitter generated by the entire system is controlled as much as possible is therefore described below.

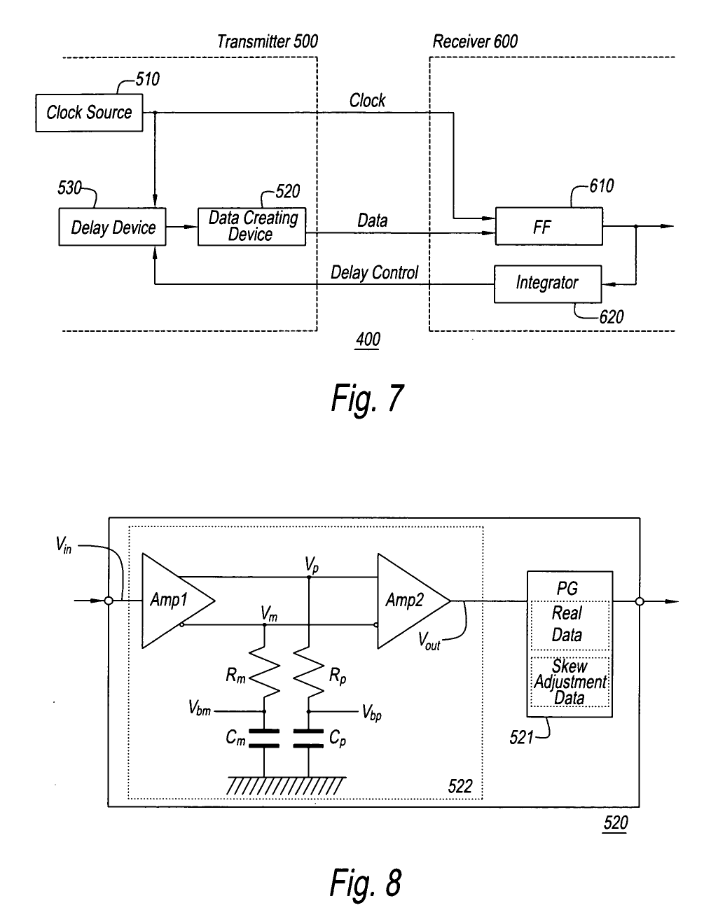

The third embodiment is similarly a serial data transmission system. Its structure is shown in FIG. 7. Serial data transmission system 400 in FIG. 7 comprises a transmitter 500 and a receiver 600.

Transmitter 500 comprises a clock generator 510, a data generator 520, and a delay device 530. Clock generator 510 is a device that has the same structure and function as clock generator 210 shown in FIG. 1. Delay device 530 is a device having the same structure and function as delay device 230 shown in FIG. 1. Data generator 520 is a device that is different from the data generator 220 in FIG. 1. Data generator 520 will therefore be described in detail. The internal block diagram of data generator 520 is shown in FIG. 8. Data generator 520 in FIG. 8 comprises a waveform adjustment device 522 and a pattern generator 521 (PG 521 in the figure). Waveform adjustment device 522 is a device having the same structure and function as waveform adjustment device 222. However, waveform adjustment device 522 adjusts the signal waveform of the clock signal to which time delay is applied by delay device 530. Pattern generator 521 generates the real data signals or skew adjustment data signals in response to both a rise or fall in the clock signal that is output from waveform adjustment device 522. It should be noted that the skew adjustment data signals are data digits that alternate between “0” and “1.” These data digits can both be pre-housed in pattern generator 521, or one can be housed in pattern generator 521, as necessary.

Receiver 600 comprises a flip-flop 610 (FF 610 in the figure) and an integrator 620. Flip-flop 610 latches data signals that are output by data generator 520 in response to the clock signal supplied from clock generator 510 and outputs the resulting signal. By means of the present embodiment, flip-flop 610 performs the latch operation in response to a rise in the clock signal. Integrator 620 is the device that receives the output signal of flip-flop 610 and detects the amount of skew between the clock signal and the data signal. Integrator 620 outputs signals that change with the amount of skew between the clock signal and the data signal. The output signals of integrator 620 are fed back to delay device 530 as delay control signals.

Moreover, serial data transmission system 400 adjusts skew by the same procedures as serial data transmission system 100.

The output signals of pattern generator 221 of serial data transmission system 100 are pattern-dependent. Serial data transmission system 100 is such that the duty ratio of the signals with this pattern dependence can be changed. On the other hand, serial data transmission system 400 is structured so that the duty ratio of clock signals, which are not pattern-dependent, is adjusted and this clock signal is input to pattern generator 521. Therefore, when compared to serial data transmission system 100, application of jitter by the waveform adjustment device can be reduced and the amount of jitter produced by the entire system can be reduced.

The inventors have thus far described embodiments that use the present invention in serial data transmission systems. However, the present invention can also be used for parallel data transmission systems. Therefore, a parallel data transmission system is described below as a fourth embodiment of the present invention.

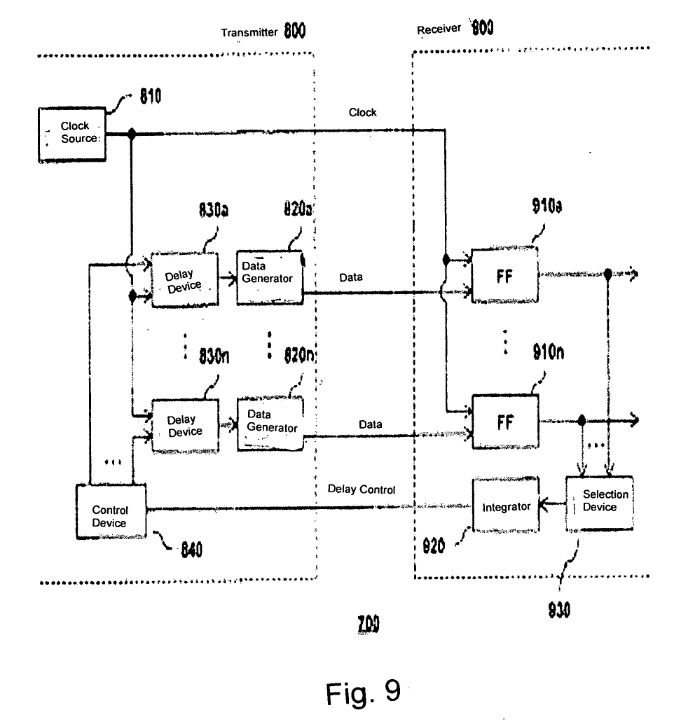

The fourth embodiment is a parallel data transmission system and its structure is shown in FIG. 9. Parallel data transmission system 700 comprises a transmitter 800 and a receiver 900.

Transmitter 800 comprises a clock generator 810, a data generator 820, a delay device 830, and a control device 840. Data generator 820 and delay device 830 comprise up to several data lines and a letter of the alphabet is affixed to the end of the reference number for their identification. Clock generator 810 is a device having the same structure and function as clock generator 210 shown in FIG. 1. Delay device 830 is a device that applies the desired delay to the received signals. It receives the clock signals from clock generator 810, applies the time delay, and outputs the resulting signal. The amount of delay applied by delay device 830 to received signals increases or decreases in response to the outside signals. Data generator 820 is a device having the same structure and function as data generator 220 shown in FIG. 1 and responds to the clock signals to which time delay has been applied by delay device 830. Control device 840 receives the delay control signals that are output from receiver 900 and selectively controls each delay device 830.

Receiver 900 comprises a flip-flop 910 (FF 910 in the figure), an integrator 920, and a selection device 930. Flip-flop 910 has up to several data lines and a letter of the alphabet is affixed to the end of the reference number for their identification. Flip-flop 910 latches data signals that are output by data generator 820 in response to the clock signals supplied from clock generator 810 and outputs the resulting signals. By means of this embodiment, flip-flop 910 performs latch operation in response to a rise in the clock signal. Selection device 930 selects one of the multiple output signals from flip-flop 910 and outputs this signal to integrator 920. Integrator 920 is the device that receives the output signal from flip-flop 910 that has been selected and detects the amount of skew between the clock signal and the data signal. Integrator 920 outputs signals that change with the amount of skew between the clock signal and data signal. The output signals of integrator 920 are fed back as delay control signals to control device 840.

Parallel data transmission system 700 selectively adjusts the data lines for skew with control device 840 and selection device 930. Skew adjustment in each data line is performed in the same way as the skew adjustment described in the first embodiment. It goes without saying that in this case, each amount of delay is set so that the data signals that should be latched by flip-flop 910 from receiver 900 in the same time zone are latched in this way. Of course, it is also possible to perform skew adjustment as described in the second embodiment.

Consequently, parallel data transmission system 700 can perform skew adjustment so that the effect of jitter on all of the data lines is minimized.

Now, the flip-flop installed inside any of the transmission systems of the embodiments can also perform latching in response to a fall, instead of a rise, in the clock signal.

As described above in detail, the present invention has the above-mentioned structure and operation. By means of a data transmission system with which clock signals and data signals are individually transmitted and received and which comprises a transmitter, a receiver, and a delay device for adjusting skew between the above-mentioned clock signals and the above-mentioned data signals, the above-mentioned transmitter transmits skew adjustment signals, which are alternating binary digit signals having twice the period of the above-mentioned clock signals and one signal state of which persists for a longer time than the other signal state, in place of data signals, the above-mentioned receiver samples the above-mentioned skew adjustment signals in response to the above-mentioned clock signals and creates delay control signals that change with the statistical properties of the above-mentioned skew adjustment signals that have been sampled, and the above-mentioned delay device adjusts the above-mentioned time delay in response to the above-mentioned delay control signals. Therefore, a data system with a simple structure having a skew adjustment function can be presented. Thus, miniaturization, a reduction in cost, and the like for the data transmission system can be promoted. Moreover, as shown in the first embodiment, delay is controlled using the clock signal and not the data signal and therefore, jitter derived from the system can be reduced. Moreover, as shown by the first embodiment, by means of the above-mentioned data transmission system, delay control signals in which peaks or dips periodically appear are generated and the above-mentioned amount of delay is adjusted while referring to these signals. Therefore, optimal skew adjustment can be precisely performed. Furthermore, as shown in the second embodiment, the amount of delay of the above-mentioned delay device is adjusted to the amount of delay obtained by subtracting the original time delay from the ideal time delay. The above-mentioned ideal time delay is the time delay with which the probability that the transition of clock signals and the transition of data signals will occur simultaneously is at its lowest. The original time delay is the amount of skew that is still present between the clock signals and the data signals, even when said time delay is adjusted to its lowest, and is calculated from each of the time delays adjusted for at least two transmission rates. As original time delay is calculated accurately, high-speed skew adjustment at any transmission rate is possible. This effect is particularly marked in measurement devices and the like, in which the transmission rate changes as needed in accordance with the test parameters.

What is claimed is:

1. A skew adjustment method, where skew between clock signals and data signals is adjusted by changing a time delay applied to said clock signals or said data signals in a data transmission system wherein clock signals and data signals are individually transmitted and received, skew adjustment method comprises:
transmitting skew adjustment signals, which are alternating binary digit signals having twice the period of said clock signals and one signal state that persists for a longer time than the other signal state, in place of data signals,
sampling said skew adjustment signals in response to said clock signals,
creating delay control signals that change with a statistical property of said skew adjustment signals that have been sampled, and
adjusting said time delay in response to said delay control signals.

2. The skew adjustment method according to claim 1, wherein said delay control signals are created by integrating said skew adjustment signals that have been sampled.

3. The skew adjustment method according to claim 1, wherein said skew adjustment signals are asymmetric rectangular waves having twice a period of said clock signals.

4. The skew adjustment method according to any of claims 1, wherein said time delay is applied to said data signals and said skew adjustment signals.

5. The skew adjustment method according to any of claims 1, wherein:
said time delay is an amount of delay obtained by subtracting an original time delay from an ideal time delay, said ideal time delay being a time delay with which the probability that transition of clock signals and transition of data signals will occur simultaneously is at its lowest, and said original time delay being an amount of skew that is present between said clock signals and said data signals, even when said time delay is adjusted to its lowest, and is calculated from each of the time delays adjusted for at least two transmission rates.

6. A skew adjustment apparatus, for adjusting skew between clock signals and data signals in a data transmission system wherein clock signals and data signals are individually transmitted and received, said skew adjustment apparatus comprises:
a transmitter for transmitting skew adjustment signals, which are alternating binary digit signals having twice the period of said clock signals and one signal state of which persists for a longer time than the other signal state, in place of data signals,
a sampler for sampling said skew adjustment signals in response to said clock signals,
a delay control device for creating delay control signals that change with the statistical properties of said skew adjustment signals that have been sampled, and
a data creating device for applying the time delay to said skew adjustment signals or said clock signals in response to said delay control signals.

7. The skew adjustment apparatus according to claim 6, wherein said delay control device for creating said delay control signals creates said delay control signals by integrating said skew adjustment signals that have been sampled.

8. The skew adjustment apparatus according to claim 6, wherein said skew adjustment signals are asymmetric rectangular waves having twice a period of said clock signals.

9. The skew adjustment apparatus according to any of claims 6, wherein said time delay means applies a delay to said data signals and said skew adjustment signals.

10. The skew adjustment apparatus according to any of claims 6, wherein said time delay is an amount of delay obtained by subtracting an original time delay from an ideal time delay, said ideal time delay being the time delay with which a probability that transition of clock signals and transition of data signals will occur simultaneously is at its lowest, and said original time delay being an amount of skew that is present between said clock signals and said data signals, even when said time delay is adjusted to its lowest, and is calculated from each of said time delays adjusted for at least two transmission rates.

11. A data transmission system, having clock signals and data signals individually transmitted and received, said system comprising:
a transmitter;
a receiver; and
a delay device for adjusting skew between said clock signals and said data signals;
wherein said transmitter transmits said clock signals and skew adjustment signals, which are alternating binary digit signals having twice the period of said clock signals and one signal state of which persists for a longer time than the other signal state, said receiver samples said skew adjustment signals in response to said clock signals and creates delay signals that change with a statistical property of said skew adjustment signals that have been sampled, and said delay device adjusts an amount of delay in response to said delay control signals.

12. The data transmission system according to claim 11, wherein said receiver creates delay control signals by integrating said skew adjustment signals that have been sampled.

13. The data transmission system according to claim 11, wherein said skew adjustment signals are asymmetric rectangular waves having twice a period of said clock signals.

14. The data transmission system according to claim 11, wherein said delay device delays said data signals and said skew adjustment signals.

15. The data transmission system according to claim 11, wherein said time delay is an amount of delay obtained by subtracting an original time delay from an ideal time delay, said ideal time delay being a time delay with which the probability that transition of clock signals and transition of data signals will simultaneously occur is at its lowest, and said original time delay being an amount of skew that is present between said clock signals and said data signals, even when said time delay is adjusted to its lowest, and is calculated from each of the time delays adjusted for at least two transmission rates.

16. The data transmission system according to claim 11, wherein said transmitter and said receiver are connected together by clock signal lines and data signal lines, and said transmitter supplies said clock signals to said clock signal lines and said skew adjustment signals to said data signal lines.

17. The data transmission system in any of claims 11, wherein said transmitter comprises said delay device and a binary signal generator that generates said data signals and said skew adjustment signals, said binary signal generator generates said data signals and said skew adjustment signals in response to both rising edges and trailing edges of said clock signals.
